(19) United States
(12) Patent Application Publication
(10) Pub. No.: US 2008/0181205 A1
(43) Pub. Date: Jul. 31, 2008

(54) Method to improve the performance of handoffs between packet switched and circuit switched domains

(76) Inventors: Maria Rg Azada, Naperville, IL (US); Michael Francis Dolan, Bolingbrook, IL (US); I-Fong Antonio Wu, Hackettstown, NJ (US)

Correspondence Address: Alcatel-Lucent;Docket Administrator - Room 2F-190, 600-700 Mountain Ave., Murray Hill, NJ, 07974-0636, US

(21) Appl. No.: 11/699,540

(22) Filed: Jan. 26, 2007

(51) Int. Cl. H04L 12/66

(52) U.S. Cl. 370/355

(57) ABSTRACT

A method and apparatus is described for coordinating the movement of communication traffic, e.g., a voice call, from a packet switched (PS) domain to a circuit switched (CS) domain in the case that the terminal device cannot communicate with the PS and CS radio technologies simultaneously. Such movement involves the parallel activities of moving the bearer traffic routing from the PS domain to the CS domain, and of moving the radio connection from the PS radio access network to the CS radio access network. An adjustable timer is used to delay either the movement of the terminal device from the PS radio technology to the CS radio technology, or to delay the movement of bearer traffic from the PS domain to the CS domain in order to minimize the gap in bearer traffic delivery to and from the terminal device. In addition, in the case of delaying the movement at the radio access level, additional signaling is described to obtain new radio data that can improve the success rate for movement between the radio access technologies.

### FIELD OF THE INVENTION

The present invention relates generally to communication systems, and more particularly to the handoff of voice and data calls from a packet switched (PS) domain to a circuit switched (CS) domain.

### BACKGROUND OF THE INVENTION

Packet switched (PS) technologies are being applied to telephony, in particular to the delivery of voice calls. In prior art systems, voice calls were delivered only via circuit switched (CS) networks. In the area of cellular telephony, older CS technology continues to be used while regions of PS technology grow. Terminal devices may begin calls while in the coverage area of PS technology, but move into coverage areas that include only the CS technology. One problem with the current technology is in continuing such calls, particularly voice calls, across the switch from PS to CS technologies.

While moving communications from PS to CS technologies, a critical factor is whether the terminal device has the ability to communicate with the network over both the PS and CS domains. If simultaneous communication over both domains is possible, for instance, through the use of two separate transmit/receive capabilities in the terminal device, then the transition from PS to CS domains can be characterized as a make-before-break operation.

If, on the other hand, the terminal device has only a single transmit/receive capability, the movement from the PS to CS domain while maintaining a call becomes more challenging. One proposed solution is to have a PS radio technology to carry CS signaling. This technique is used to reduce the time it takes to transition a call from the PS domain to the CS domain, when the terminal device has only a single transmit/receive capability.

A problem still exists in the single transmit/receive capability case, however, when the cellular radio access networks for the PS and CS domains do not coordinate the movement of the terminal device from PS radio technology to CS radio technology with the movement of the bearer traffic from the PS domain to the CS domain.

The procedures needed to transition between these fully established bearer states when only a single transmit/receive capability exists may take a different amount of time as compared to the time needed to transition the terminal device from the PS radio technology to the CS radio technology. Movement between radio technologies is asynchronous to the movement of the bearers from the PS domain to the CS domain.

The movement of the terminal device from PS to CS radio technologies occurs in parallel to the movement of the bearer from the PS domain to the CS domain. The undesirable results of the asynchronous nature of these movements are that, if the movement of the bearer takes longer than the movement between the radio technologies, the terminal device may leave the PS radio technology before the bearer is removed from the PS domain, and may arrive on the CS radio technology before the bearer is fully deliverable over the CS domain. Additionally, there is variability in the time it takes to move the bearer from the PS domain to the CS domain that is dependent on the speed of bearer handling at the equipment supporting the bearer, the latencies in the signaling paths used to move the bearers, and loading factors on the signaling networks involved in moving the bearer.

One additional problem is that the movement of the terminal device from the PS radio access technology to the CS radio access technology may take longer than the movement of the bearer traffic stream from the PS domain to the CS domain. The result in this case would be that the bearer traffic may be removed from the PS domain prior to the departure of the terminal device from the PS radio access network, and the bearer traffic may be established via the CS domain prior to completion of the communication path from the terminal device to the CS radio access network.

On the radio technology side, it is important to move the terminal device to the CS radio technology before coverage of the PS radio technology decreases to a point where reliable signaling between the terminal device and the radio access networks is no longer possible. It is also important to choose the radio access points, such as base station sectors, in the CS radio technology that will provide the best radio communication between the CS radio access network and the terminal device. If power strength measurements and other data commonly used to select a radio channel become old, they may no longer accurately reflect the radio conditions for the terminal device, and successfully moving from the PS radio technology to the CS radio technology can become difficult.

Therefore, a need exists for a method of moving a terminal device from a packet switched (PS) domain to a circuit switched (CS) domain without the problems associated with the prior art.

### BRIEF SUMMARY OF THE INVENTION

The present invention allows the movement of bearer traffic from a PS domain to a CS domain to be initiated while the terminal device continues to process bearer traffic over the PS domain using the PS radio technology. This minimizes the voice gap during the handoff procedure so that the handoff success rate is improved.

At a point in time that is adjustable, the movement of the terminal device, commonly referred to as handoff, from the PS radio technology to the CS radio technology is initiated also. This point in time is chosen to coordinate the establishment of communications of the terminal device over the CS radio access network. Moreover, this point in time is also chosen to allow fresh radio data, such as power strength measurements, to be obtained and used to provide the best radio environment on the CS radio technology to maximize the success rate of movement of the terminal device from the PS radio technology to the CS radio technology. This facilitates successful handoff from the PS radio network to the CS radio network.

In accordance with an exemplary embodiment of the present invention, a call origination message triggers movement of the bearer traffic from the PS domain to the CS domain. This message is preferably sent from the terminal device over the PS radio access network and is forwarded from the PS radio access network to the CS radio access network.

The CS radio access network forwards the message to the call control components of the CS domain, for example the Mobile Switching Center (MSC). The CS radio access network sets a timer for an operator controlled amount of time.

The MSC sends signaling that initiates movement of the bearer traffic for the call from the PS domain to the CS domain.

When the timer set by the CS radio access network expires, the CS radio access network sends a request to the PS radio access network for updated radio data for the terminal device. An example of updated radio data includes power strength measurements.

The PS radio access network obtains updated radio data and sends it to the CS radio access network. The CS radio access network uses the radio data to establish a radio environment, e.g., a radio traffic channel, that will be used for communicating signaling and bearer traffic with the terminal device.

The CS radio access network formulates and sends a message to the PS radio access network. This message is forwarded by the PS radio access network to the terminal device, and initiates movement of the terminal device from the PS radio technology to the CS radio technology.

The terminal device moves to the CS radio technology and completes establishment of communication with the CS radio access network. The movement comes, for example, when the terminal device executes a handoff. The bearer traffic is delivered to the terminal device via the CS domain.

In summary, the present invention provides for the use of a timer to delay setting up the CS radio access network environment for the terminal device, while the bearer traffic movement from the PS domain to the CS domain is initiated.

In addition, the present invention may use the timer to delay the bearer traffic movement from the PS domain to the CS domain while establishment of the CS radio access network environment for the terminal device is initiated. The timer is preferably adjustable so that the coordination is optimized for the completion of the setup of the CS radio environment for the terminal device and the delivery of the bearer traffic via the CS domain.

The CS radio access network may request new radio data, such as power strength measurements, from the PS radio access network. The PS radio access network obtains and supplies requested new radio data to the CS radio access network.

### BRIEF DESCRIPTION OF THE SEVERAL VIEWS OF THE DRAWINGS

FIG. 1 depicts an exemplary view of the timing aspects of asynchronous movement of a terminal device from a PS radio technology to a CS radio technology, and of the bearer traffic from the PS domain to the CS domain, when the voice gap is due to radio movement in accordance with an exemplary embodiment of the present invention.

FIG. 2 depicts an exemplary view of the timing aspects of asynchronous movement of a terminal device from a PS radio technology to a CS radio technology, and of the bearer traffic from the PS domain to the CS domain, when the voice gap is due to bearer movement in accordance with an exemplary embodiment of the present invention.

FIG. 3 depicts an exemplary view of the timing aspects of asynchronous movement of a terminal device from a PS radio technology to a CS radio technology, and of the bearer traffic from the PS domain to the CS domain, when the voice gap is due to bearer movement that is initiated before the radio move in accordance with an exemplary embodiment of the present invention.

FIG. 4 depicts a flow diagram of a method for minimizing the bearer traffic gap when the bearer movement delay is greater than the radio movement delay in accordance with an exemplary embodiment of the present invention.

FIG. 5 depicts a flow diagram of a method for minimizing the bearer traffic gap when the radio movement delay is greater than the bearer movement delay in accordance with an exemplary embodiment of the present invention.

### DETAILED DESCRIPTION OF THE INVENTION

The present invention provides a method for improving the performance of handoffs between packet switched and circuit switched domains. In a network, both PS Radio Access Networks and CS Radio Access Networks may be available in a subset of the region.

In accordance with an exemplary embodiment of the present invention, the movement of a call from a packet switched network to a circuit switched network occurs in four major stages. The first stage preferably comprises bearer traffic and signaling being conveyed from a Call Control and Bearer Control to a PS Domain. The traffic and signaling then is conveyed to a PS Radio Access Network and finally to a terminal device. Traffic may be flowing in both directions to and from the terminal device.

The second stage preferably includes signaling established via a path from the Terminal Device through the PS Radio Access Network and then to the CS Radio Access Network. The CS Radio Access Network then conveys the signaling to the CS Domain. The signaling is then conveyed from the CS Domain to the Call Control and Bearer Control.

The third stage preferably includes the movement of the bearer traffic and signaling from the packet switched components to the circuit switched components. Bearer traffic flowing to the terminal device is now being sent from the Call Control and Bearer Control to the CS Domain and then to the CS Radio Access Network, and finally to the terminal device. Any remaining bearer traffic in the direction toward the terminal device previously sent from the Call Control and Bearer Control to the PS Domain and then to the PS Radio Access Network, and finally to the terminal device continues to flow. Likewise any bearer traffic previously sent by the terminal device to the PS Radio Access Network continues to flow through the PS Domain and then to the Call Control and Bearer Control.

The fourth stage preferably comprises the final state of the movement of the bearer traffic to the CS domain. Signaling and bearer traffic paths between the terminal device and the PS Radio Access Network are preferably no longer in use. Similarly, signaling and bearer traffic paths between the PS Radio Access Network and the PS Domain and between the PS domain and the Call Control and Bearer Control relative to the terminal device are preferably no longer in use.

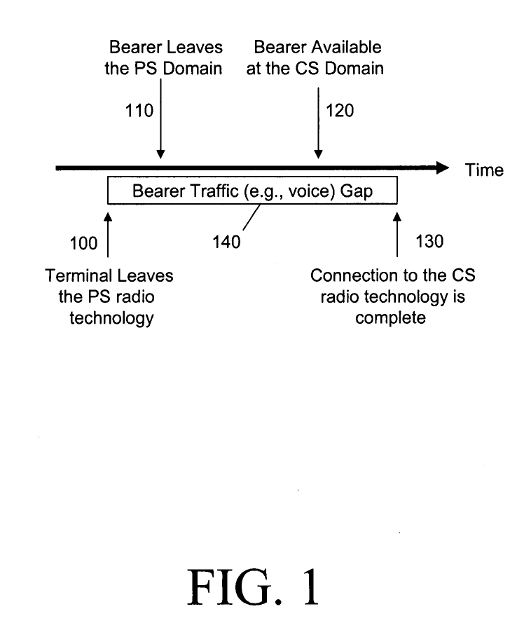

FIG. 1 depicts an exemplary view of the timing aspects of asynchronous movement of the terminal device from the PS radio technology to the CS radio technology, and of the bearer traffic from the PS domain to the CS domain. Specifically, at point in time 100 the terminal device leaves the PS radio technology is such a way that it is no longer sending and receiving signaling and bearer traffic via the PS domain. At point in time 110 the bearer traffic is no longer being sent and received from the PS domain. At point in time 120 the bearer traffic becomes available on the CS domain. At point in time 130 the terminal device completes connection procedures with the CS radio technology in such as way that it can send and receive signaling and bearer traffic via the CS domain. These actions result in a Bearer Traffic Gap (e.g., a voice gap) 140 that preferably begins at time 100 and ends at time 130. This Bearer Traffic Gap 140 is as perceived by the user of that terminal device. Specifically in FIG. 1, Bearer Traffic Gap 140 is preferably minimized by reduction in the radio connection time.

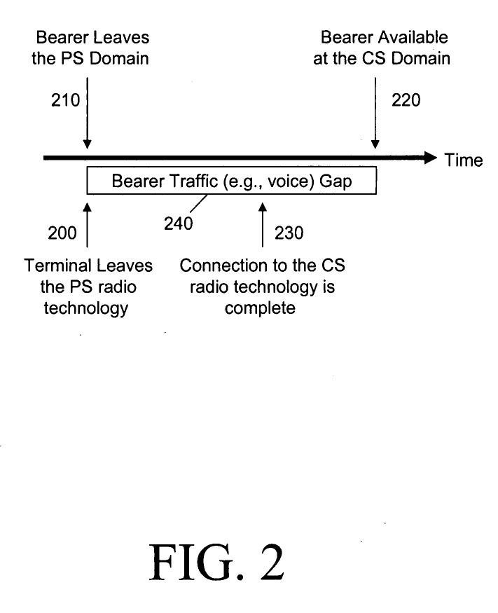

FIG. 2 depicts an exemplary view of the timing aspects of asynchronous movement of the terminal device from the PS radio technology to the CS radio technology, and of the bearer traffic from the PS domain to the CS domain. In accordance with an exemplary embodiment, at point in time 200 the terminal device leaves the PS radio technology is such a way that it is no longer sending and receiving signaling and bearer traffic via the PS domain. At the same point in time 210 the bearer traffic is no longer being sent and received from the PS domain. At point in time 220 the bearer traffic becomes available on the CS domain. At point in time 230 the terminal device completes connection procedures with the CS radio technology in such as way that it can send and receive signaling and bearer traffic via the CS domain. These actions result in a Bearer Traffic Gap (e.g., a voice gap) 240 that begins at time 200 and ends at time 220. This Bearer Traffic Gap 240 is as perceived by the user of that terminal device. In accordance with the exemplary embodiment depicted in FIG. 2, the Bearer Traffic Gap 240 is minimized by reduction in the bearer movement time between the PS domain and the CS domain.

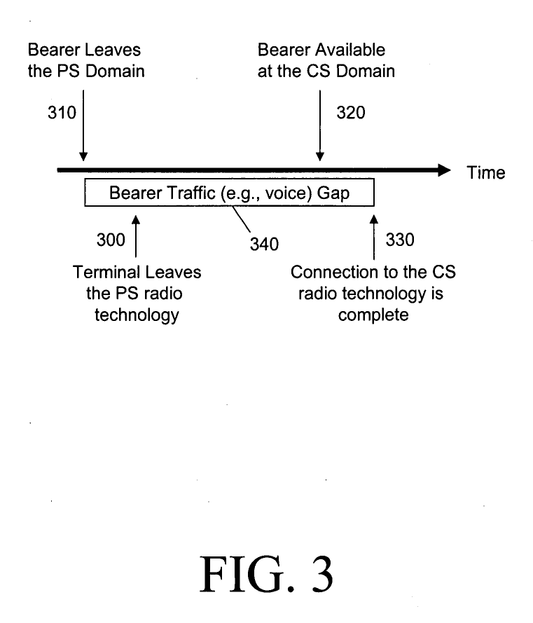

FIG. 3 depicts an exemplary view of the timing aspects of asynchronous movement of the terminal device from the PS radio technology to the CS radio technology, and of the bearer traffic from the PS domain to the CS domain. Specifically, at point in time 300 the terminal device leaves the PS radio technology is such a way that it is no longer sending and receiving signaling and bearer traffic via the PS domain. However, at point in time 310 the bearer traffic is no longer being sent and received from the PS domain, and this occurs prior to point in time 300. At point in time 320 the bearer traffic becomes available on the CS domain. At point in time 330 the terminal device preferably completes connection procedures with the CS radio technology in such as way that it can send and receive signaling and bearer traffic via the CS domain. These actions preferably result in a Bearer Traffic Gap (e.g., a voice gap) 340 that begins at time 310 and ends at time 330. The Bearer Traffic Gap 340 is as perceived by the user of that terminal device. The Bearer Traffic Gap 340 is preferably minimized by coordinating the point in time 330 when the terminal device can send and receive signaling and bearer traffic over the CS radio technology with the point in time 320 when the CS domain is prepared to send and receive bearer traffic.

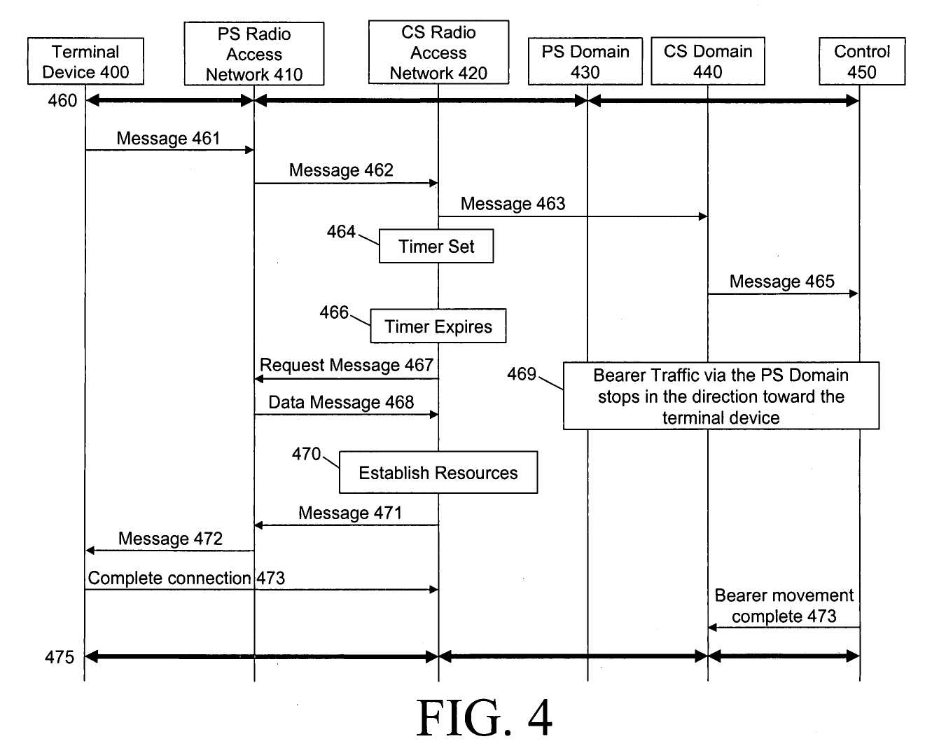

FIG. 4 provides an exemplary view of the communications between various entities to minimize the bearer traffic gap, e.g., voice gap, when the time to move the bearer traffic from PS domain 430 to CS domain 440 is longer than the time to move terminal device 400 from attachment to PS radio access network 410 to attachment to CS radio access network 420.

Terminal Device 400 communicates bearer traffic 460 with PS Radio Access Network 410. PS Radio Access Network 410 communicates that same bearer traffic 460 with PS Domain 430, which in turn communicates the bearer traffic 460 with another external node under control of Control function 450.

Message 461 is sent from Terminal Device 400 to PS Radio Access Network 410 to initiate bearer movement to CS domain 440.

Message 462 is forwarded to CS Radio Access Network 420. Message 462 initiates bearer movement to CS Domain 440. In accordance with an exemplary embodiment, PS Radio Access Network 410 forwards message 461 as message 462.

A message 463 to initiate bearer movement from PS domain 430 to CS domain 440 is sent from CS Radio Access Network 420 to CS Domain 440.

CS Radio Access Network 420 sets (464) an adjustable internal timer to delay the initiation of the procedures to move Terminal Device 400 from PS Radio Access Network 410 to CS Radio Access Network 420.

CS Domain 440 sends a message 465 to Control function 450 to initiate bearer movement to CS domain 440.

At some point, the internal adjustable timer set expires (466). At this point, CS Radio Access Network 420 has delayed initiation of the procedures to move Terminal Device 400 from PS Radio Access Network 410 to CS Radio Access Network 420 for the desired amount of time.

CS Radio Access Network 420 sends message 467 to request new radio data from PS Radio Access Network 410 to base its resource establishment procedures on data that accurately represents, as closely as possible, the current radio environment of Terminal Device 400. Use of this new radio data will help to maximize the success rate at which Terminal Device 400 acquires a connection to CS Radio Access Network 420.

PS Radio Access Network 410 provides the new radio data 468 requested.

Control function 450 moves (469) the bearer traffic off of PS Domain 430 onto CS Domain 440. It is possible that some bearer traffic in the direction of Terminal Device 400 toward the other end point of the communication may continue as any bearer traffic in transit through the packet switched network will-continue to flow upward from Terminal Device 400. In accordance with an exemplary embodiment, step 469 occurs after step 465 and prior to step 474.

CS Radio Access Network 420 internally allocates (470) and coordinates resources that will be used to support the attachment of Terminal Device 400 to CS Radio Access Network 420.

CS Radio Access Network 420 sends a message 471 to the PS Radio Access Network 410 to initiate the connection of Terminal Device 400 to CS Radio Access Network 420.

PS Radio Access Network 410 forwards message 471 as message 472 to Terminal Device 400 to initiate the connection of Terminal Device 400 to CS Radio Access Network 420.

Terminal Device 400 completes (473) the connection establishment procedures necessary to attach to CS Radio Access Network 420.

Control function 450 indicates (474) to CS Domain 440 the completion of the movement of the bearer traffic to the circuit switched network.

In step 475, bearer traffic is able to flow in both directions between Terminal Device 400 and CS Radio Access Network 420, between CS Radio Access Network 420 and CS Domain 440, and between CS Domain 440 and Control 450.

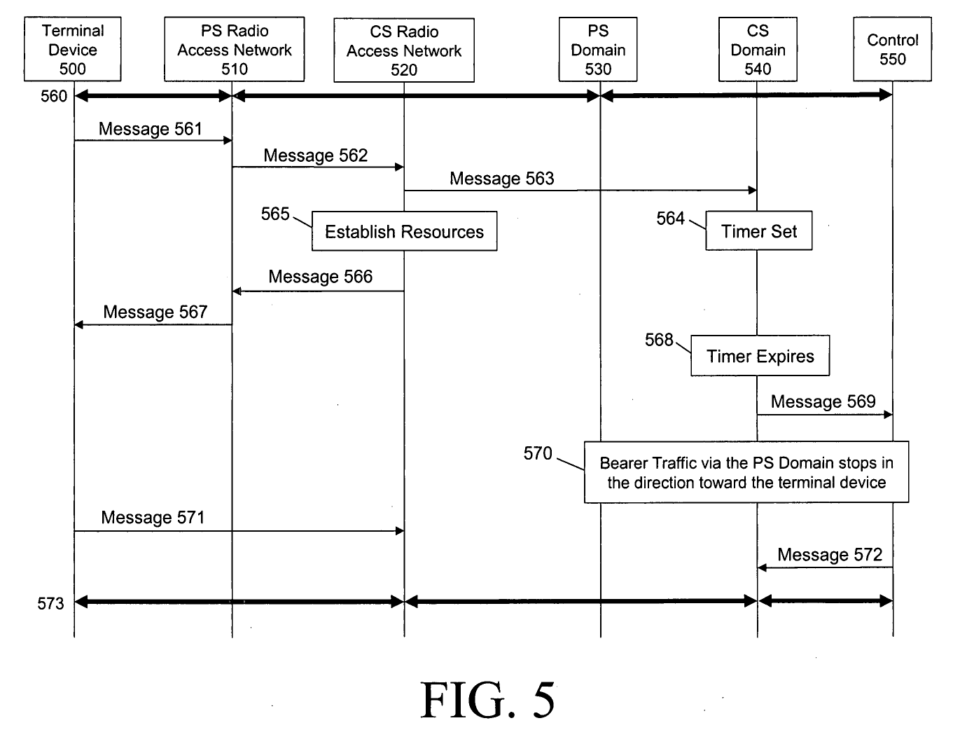

FIG. 5 provides an exemplary view of the communications between various entities to minimize the bearer traffic gap, e.g., voice gap, when the time to move the bearer traffic from PS domain 530 to CS domain 540 is shorter than the time to move terminal device 500 from attachment to PS radio access network 510 to attachment to CS radio access network 520.

In step 560, Terminal Device 500 communicates bearer traffic with PS Radio Access Network 510. PS Radio Access Network 510 communicates that same bearer traffic with PS Domain 530, which in turn communicates the bearer traffic with another external node under control of the Control function 550.

Message 561 is sent from Terminal Device 500 to PS Radio Access Network 510 to initiate bearer movement to CS domain 540.

Message 562 is forwarded to CS Radio Access Network 520 to initiate bearer movement to CS Domain 530.

Message 563 is sent to CS Domain 540 to initiate bearer movement from PS domain 530 to CS domain 540 is sent from CS Radio Access Network 520 to CS Domain 540.

CS Domain 540 sets (564) an adjustable internal timer to delay the initiation of the procedures to move the bearer traffic from PS Domain 530 to CS Domain 540.

CS Radio Access Network 520 internally allocates and coordinates (565) resources that will be used to support the attachment of Terminal Device 500 to CS Radio Access Network 520.

CS Radio Access Network 520 sends message 566 to PS Radio Access Network 510 to initiate the connection of Terminal Device 500 to CS Radio Access Network 520.

PS Radio Access Network 510 forwards message 566 as message 567 to Terminal Device 500 to initiate the connection of Terminal Device 500 to CS Radio Access Network 520.

In step 568, the internal adjustable timer set in step 564 expires. At this point, CS Domain 540 has delayed initiation of the procedures to move the bearer traffic from PS Domain 530 to CS Domain 540 for the desired amount of time.

CS Domain 540 sends message 569 to Control function 550 to initiate bearer traffic movement from PS Domain 530 to CS Domain 540.

In step 570, Control function 550 moves the bearer traffic off of PS Domain 530 onto CS Domain 540. It is possible that some bearer traffic in the direction of Terminal Device 500 toward the other end point of the communication may continue as any bearer traffic in transit through the packet switched network will continue to flow upward from Terminal Device 500.

Terminal Device 500 completes the connection establishment procedures necessary to attach to CS Radio Access Network 520 by sending message 571 to CS Radio Access Network 520.

In step 572, Control function 550 indicates to CS Domain 540 the completion of the movement of the bearer traffic to the circuit switched network by sending message 572.

In step 573, bearer traffic is able to flow in both directions between Terminal Device 500 and CS Radio Access Network 520, between CS Radio Access Network 520 and CS Domain 540, and between CS Domain 540 and Control 550.

The present invention thereby provides a solution to the situation in which the parallel movements of a terminal device between PS and CS radio technologies, and of the bearer traffic stream between the PS and CS domains includes a gap in a voice call during such movements. In this situation, there is a desire to minimize the gap in a voice call during such movements. In addition, there is a need to maximize the success rate of movement of the terminal device between PS and CS radio technologies. The present invention solves these problems in an exemplary embodiment by beginning the parallel movement operations soon enough so that the terminal device will be able to reliably receive all signaling necessary on the PS radio technology. In addition, the present invention solves the problems of the prior art by using additional radio data obtained from the PS Radio Access Network, such as power strength measurements, to properly set up the radio environment in the CS Radio Access Network, such as a radio traffic channel. In addition, the present invention allows a terminal device to remain on the PS radio technology until such time as its arrival on the CS radio technology can be coordinated with the completion of bearer traffic establishment on the CS domain.

While this invention has been described in terms of certain examples thereof, it is not intended that it be limited to the above description, but rather only to the extent set forth in the claims that follow.

We claim:

1. A method for handing off a terminal device from a packet switched domain to a circuit switched domain, the method comprising:
moving the terminal device from the packet switched domain to the circuit switched domain at a first time; and
moving bearer traffic associated with the terminal device from the packet switched domain to the circuit switched domain at a second time that is later than the first time.

2. A method for handing off a terminal device from a packet switched domain to a circuit switched domain in accordance with claim 1, wherein the second time is determined by using a timer.

3. A method for handing off a terminal device from a packet switched domain to a circuit switched domain in accordance with claim 2, wherein the timer is established at the circuit switched domain.

4. A method for handing off a terminal device from a packet switched domain to a circuit switched domain in accordance with claim 2, wherein the timer is adjustable.

5. A method for handing off a terminal device from a packet switched domain to a circuit switched domain, the method comprising:
moving bearer traffic associated with the terminal device from the packet switched domain to the circuit switched domain at a first time; and
moving the terminal device from the packet switched domain to the circuit switched domain at a second time that is later than the first time.

6. A method for handing off a terminal device from a packet switched domain to a circuit switched domain in accordance with claim 5, wherein the second time is determined by using a timer.

7. A method for handing off a terminal device from a packet switched domain to a circuit switched domain in accordance with claim 6, wherein the timer is established at the circuit switched domain.

8. A method for handing off a terminal device from a packet switched domain to a circuit switched domain in accordance with claim 6, wherein the timer is adjustable.

9. A method for handing off a terminal device from a packet switched domain to a circuit switched domain in accordance with claim 5, the method further comprising the step of transmitting signaling from the circuit switched domain to the packet switched domain to obtain new radio data.

10. A method for handing off a terminal device from a packet switched domain to a circuit switched domain in accordance with claim 9, the method further comprising the step of sending new radio data from the packet switched domain to the circuit switched domain to provide in response to the signaling.

11. A method for handing off a terminal device from a packet switched domain to a circuit switched domain in accordance with claim 10, wherein the new radio data comprises power strength measurements.
